(19) United States
(12) Patent Application Publication
(10) Pub. No.: US 2009/0097066 A1
(43) Pub. Date: Apr. 16, 2009

(54) JOB HISTORY MANAGING SYSTEM, CONTROL METHOD THEREFOR, AND STORAGE MEDIUM

(75) Inventor: Naobumi Fukudome, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/293,002

(22) PCT Filed: Mar. 14, 2007
(86) PCT No.: PCT/JP2007/055779

§ 371 Date: Sep. 15, 2008

(30) Foreign Application Priority Data
Mar. 15, 2006 (JP) 2006-070958
Feb. 26, 2007 (JP) 2007-045173

(51) Int. Cl. G06F 15/00; G06F 17/30; G06F 7/06

(52) U.S. Cl. 358/1.15; 707/104.1; 707/4; 707/E17.021; 707/E17.023; 707/E17.014

(57) ABSTRACT

A job history managing system which is capable of efficiently narrowing down a corresponding job, even if image information has been leaked, and eliminating variation in search results to realize the search result with a high accuracy. The job history managing system has a client PC 11 as a job outputting apparatus. The job history managing system includes a print server 12 that collects job tracking information including search target image which is image information related to output contents of a job outputted from the client PC 11, an archive server 15 that accumulates the job tracking information collected by the print server 12, an image search server 16 that extracts and registers a characteristic value of the image information on the search target image in the job tracking information accumulated by the archive server 15, and a switching unit that switches a process of extracting the characteristic value of the image information on the search target image, depending on a generation condition of the job.

### BACKGROUND OF THE INVENTION

1. Technical Field

The present invention relates to a job history managing system of an information processing apparatus, a printing apparatus, a multi function peripheral and the like, a control method therefore, and a storage medium, which are suitable to accumulate contents of a job outputted from a printing apparatus or a multi function peripheral and track the same.

2. Background Art

There is a conventional system configured with an information processing apparatus such as a personal computer (hereinafter referred to as “the PC”), a printing apparatus such as a printer, and a job outputting apparatus such as an MFP (Multi Function Peripheral) having multiple functions (Copy, Print and Send) and the like.

With respect to the above described system, a technique related to an information leakage prevention system has been proposed of accumulating contents of a job outputted by a user from the printing apparatus or the job outputting apparatus and tracking when, who has executed what kind of job (refer to Japanese Laid-Open Patent Publication (Kokai) No. 2002-149371 and Japanese Laid-Open Patent Publication (Kokai) No. 2004-118243, for example). The above described proposal has adopted a method of accumulating printing data outputted by the user from the printing apparatus and log information (a name of the user who has outputted the job, date and time of the output and the like), and tracking the contents of the job from the log information when an information leakage occurs.

On the other hand, a technique related to an image search for comparing and collating multiple search target images and a collation image and then searching the search target images has been proposed (refer to Japanese Laid-Open Patent Publication (Kokai) No. 2000-306095, for example). The above described proposal has adopted a method of estimating a generation condition of a collation image to be inputted, and from the generation condition, generating the collation image so that it becomes closer to a generation condition of the search target image.

However, in the job tracking method disclosed in Japanese Laid-Open Patent Publication (Kokai) No. 2002-149371 and Japanese Laid-Open Patent Publication (Kokai) No. 2004-118243 as described above, the corresponding job is narrowed down depending on the name of the user who has outputted the job, the date and time of the output and the like, which causes a problem of a troublesome task when narrowing down the job. Particularly, if image information related to photos or designs and the like has been leaked, in order to narrow down the job corresponding to the image information, it is necessary to finally perform a task of checking images of jobs chosen as likely to be the corresponding job, one by one, which takes a significant effort.

In addition, the image search method disclosed in the above described Japanese Laid-Open Patent Publication (Kokai) No. 2000-306095 can cover variation in the generation condition of the collation image. However, this method compares the image which is relatively near an original image with the search target image having variation with respect to the original image, in the same comparison and collation process, which causes variation in similarity in search results. It should be noted that the image which is relatively near the original image is the image outputted by a Print job. On the other hand, the image outputted by a job requiring scanning of an original, such as the image of a Copy job or a Send job, changes in its image quality away from the original image to some extent.

Therefore, there is a problem in which the search result with a high accuracy cannot be obtained because, for example, the image information generated from the printing data is arranged at the upper level if the search results are sorted in the order of similarity.

It is an object of the present invention to provide a job history managing system, a control method therefor, and a storage medium which are capable of, even if the image information has been leaked, efficiently narrowing down the corresponding job, and eliminating the variation in the search results to realize the search result with the high accuracy.

### DISCLOSURE OF INVENTION

To attain the above object, in a first aspect of the present invention, there is provided a job history managing system, including a collecting unit adapted to collect job tracking information including a search target image which is image information related to output contents of a job outputted from a job outputting apparatus, a managing unit adapted to accumulate the job tracking information collected by the collecting unit, a registering unit adapted to extract and register a characteristic value of the image information on the search target image in the job tracking information accumulated by the managing unit, and a switching unit adapted to switch a process of extracting the characteristic value of the image information on the search target image, depending on a generation condition of the job.

In the first aspect of the present invention, the job tracking information can include job log information, and the job log information can include a kind of the job.

In the first aspect of the present invention, the job outputting apparatus can include a printer and a multi function peripheral, and kinds of the job outputted from the job outputting apparatus can include Print, Copy and Send.

In the first aspect of the present invention, the registering unit can be adapted to switch the process of extracting the characteristic value of the image information on the output contents of the job, depending on the kind of the job and/or whether the image information on the output contents of the job is color or gray scale.

In the first aspect of the present invention, the job history managing system further can include a comparing unit adapted to compare and collate the search target image with a collation image based on the characteristic value of the image information on the search target image registered by the registering unit, and a comparison and collation process with respect to the search target image and the collation image performed by the comparing unit is switched depending on a generation condition of the search target image.

In the first aspect of the present invention, the comparing unit can be adapted to switch the comparison and collation process with respect to the search target image and the collation image, depending on a generation condition of the collation image.

In the first aspect of the present invention, the registering unit can be adapted to extract the characteristic value based on any of luminance, color information and form in the image information.

To attain the above object, in a second aspect of the present invention, there is provided a job history managing system, including an accumulating unit that accumulates job tracking information including a search target image which is image information on output contents of a job outputted from a job outputting apparatus, a registering unit adapted to extract and register a characteristic value of the search target image in the job tracking information accumulated by the accumulating unit, a comparing unit adapted to compare and collate the search target image with a collation image based on the characteristic value of the image information on the search target image registered by the registering unit, and a switching unit adapted to switch a comparison and collation process in the comparing unit based on a generation condition of the job.

In the second aspect of the present invention, the comparing unit can be adapted to perform a presearch having a low comparison and collation accuracy and a main search having a high comparison and collation accuracy in the comparison and collation process with respect to the search target and the collation image.

In the second aspect of the present invention, preferably, the switching unit can be adapted to switch a process of the presearch performed by the comparing unit, based on the generation condition of the job.

In the second aspect of the present invention, the registering unit can be adapted to extract multiple kinds of characteristic values from the image information on the search target image and the switching unit can be adapted to switch the kind of the characteristic value to be used in the presearch performed by the comparing unit, based on the generation condition of the job.

In the second aspect of the present invention, the multiple kinds of characteristic values extracted by the registering unit can be any one of the characteristic value based on color information, and the characteristic value based on luminance and the characteristic value based on form, in the image information on the search target image.

In the second aspect of the present invention, the job tracking information can include job log information, the job log information includes a kind of the job, and the switching unit can be adapted to switch the comparison and collation process in the comparing unit, based on the kind of the job included in the job log information.

To attain the above object, in a third aspect of the present invention, there is provided a method of controlling a job history managing system, including a collecting step of collecting job tracking information including search target image which is image information related to output contents of a job outputted from a job outputting apparatus, a managing step of accumulating the job tracking information collected by the collecting step, a registering step of extracting and registering a characteristic value of the image information on the search target image in the job tracking information accumulated by the managing step, and a controlling step of switching a process of extracting the characteristic value of the image information on the search target image, depending on a generation condition of the job.

To attain the above object, in a fourth aspect of the present invention, there is provided a method of controlling a job history managing system, including an accumulating step of accumulating job tracking information including search target image which is image information related to output contents of a job outputted from a job outputting apparatus, in an accumulating unit, a registering step of extracting a characteristic value of the search target image in the job tracking information accumulated by the accumulating step, and registering the characteristic value in an registering unit, a comparing step of comparing and collating the search target image with a collation image based on the characteristic value of the image information on the search target image registered by the registering step, and a switching step of switching a comparison and collation process in the comparing step, based on a generation condition of the job.

To attain the above object, in a fifth aspect of the present invention, there is provided a computer-readable storage medium storing a program for causing a computer to execute the method of controlling the job history managing system.

The above and other objects, features, and advantages of the invention will become more apparent from the following detailed description taken in conjunction with the accompanying drawings.

### BRIEF DESCRIPTION OF DRAWINGS

FIG. 1 is a block diagram showing a configuration of a job history managing system according to a first embodiment of the present invention;

FIG. 2 is a block diagram showing a hardware configuration of a client PC in FIG. 1;

FIG. 3 shows a module configuration of software operating on the client PC of FIG. 2 and a print server;

FIG. 4 shows a module configuration of software operating on an archive server of FIG. 1;

FIG. 5 shows a module configuration of software operating on an image search server of FIG. 1;

FIG. 6 shows a module configuration of software operating on an image search client of FIG. 1;

FIG. 7 is a block diagram showing a hardware configuration of an MFP in FIG. 1;

FIG. 8 shows a module configuration of software operating on the MFP of FIG. 7;

FIG. 9 is a block diagram showing flows of job tracking information and printing data in the job history managing system;

FIG. 10 shows an example of job log information in the job tracking information of FIG. 9;

FIG. 11 is a flowchart showing a procedure of a registration process executed by the image search server;

FIG. 12 is a flowchart showing a procedure of a search process executed by the image search server;

FIG. 13 is a flowchart showing a subsequent procedure of FIG. 12;

FIG. 14 illustrates a characteristic value of form; and

FIG. 15 is a flowchart showing another example of the search process executed by the image search server.

### BEST MODE FOR CARRYING OUT THE INVENTION

The present invention will now be described in detail with reference to the drawings showing preferred embodiments thereof. It should be noted that the relative arrangement of the components, the numerical expressions and numerical values set forth in these embodiments do not limit the scope of the present invention unless it is specifically stated otherwise.

Embodiments of the present invention will now be described with reference to the drawings.

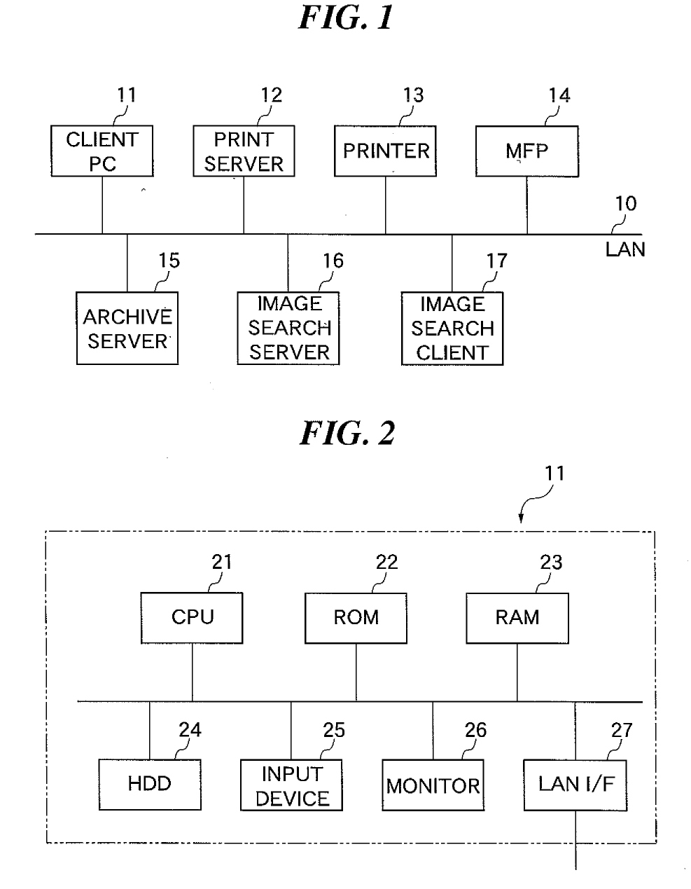

FIG. 1 is a block diagram showing a configuration of a job history managing system according to a first embodiment of the present invention.

As shown in FIG. 1, the job history managing system includes a client PC 11, a print server 12, a printer 13, an MFP 14, an archive server 15, an image search server 16 and an image search client 17. A network 10 is a communication medium for connecting the above described respective components, and is configured as a LAN in this embodiment.

The client PC 11 issues a printing instruction from an application program (hereinafter referred to as “the application”) based on a user's operation. Also, when the client PC 11 issues the printing instruction, the client PC 11 sends job tracking information to the print server 12. This function of sending the job tracking information to the print server 12 is included in a printer driver installed in the client PC 11. Here, the job tracking information is image information related output contents of a job and job log information. The image information related to the output contents of the job represents printed job contents outputted by the printer 13. The job log information will be described later.

When the print server 12 receives the printing instruction from the client PC 11, the print server 12 sends printing data to the printer 13, temporarily saves the job tracking information at the time of printing by the printer 13, and sends the job tracking information to the archive server 15. The printer 13 performs the printing according to the printing data sent from the print server 12.

The MFP 14 performs (outputs) respective jobs such as a Copy job, a Print job and a Send job, depending on the user's operation. The Send job is a protocol for transmitting image data via a facsimile, an e-mail, an FTP (File Transfer Protocol) and the like. The MFP 14 sends the tracking information on a job executed for the archive server 15. The archive server 15 accumulates the job tracking information sent from the print server 12 or the MFP 14.

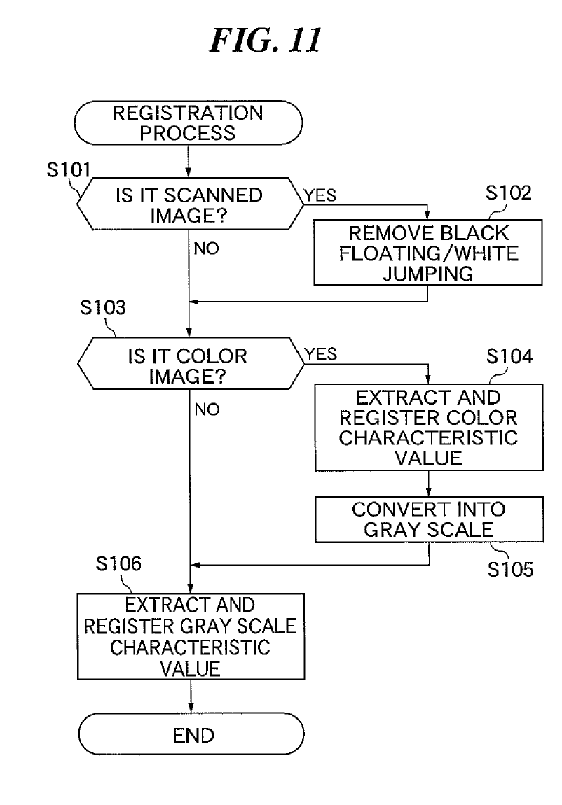

The image search server 16 has a function of extracting and accumulating a characteristic value of a search target image from document images in the job tracking information accumulated in the archive server 15. Furthermore, the image search server 16 has a function of comparing and collating the accumulated characteristic value of the search target image with a characteristic value of a collation image, and calculating similarity between the search target image and the collation image. A CPU (refer to FIG. 2) in the image search server 16 executes processes shown in flowcharts of FIGS. 11 to 13 described below, based on programs. The image search client 17 issues a search instruction to the image search server 16, and displays a result of the search from the similarities of the images which have been further calculated, in a user-friendly manner.

FIG. 2 is a block diagram showing a hardware configuration of the client PC 11 in FIG. 1. Here, since the print server 12, the archive server 15, the image search server 16, and the image search client 17 have the similar hardware configuration as the client PC 11 described below, the description thereof is omitted.

As shown in FIG. 2, the client PC 11 is configured as a general purpose PC such as a PC/AT compatible device in this embodiment. The client PC 11 includes a CPU 21, a ROM 22, a RAM 23, an HDD (hard disk drive) 24, an input device 25, a monitor 26 and a LAN I/F 27.

The CPU 21 directly or indirectly controls the above described respective components connected via an internal bus, and executes programs for realizing the processes shown in this embodiment. Basic software such as BIOS (Basic Input/Output System) is stored in the ROM 22. The RAM 23 is used as a working area for the CPU 21 or a temporary storage area for loading the programs therein. The above described programs realize a function of embedding keywords in electronic documents, managing operation authorities with respect to combinations of the keywords and user information, or accumulating the job tracking information.

The programs are stored as files in the HDD (hard disk) 24. The input device 25 is used when the user operates a program including an operation screen among the programs. The monitor 26 performs various displays including the operation screen, and is used when the user checks the operation. The LAN I/F 27 takes charge of an interface for connecting the apparatus to the network (LAN) 10.

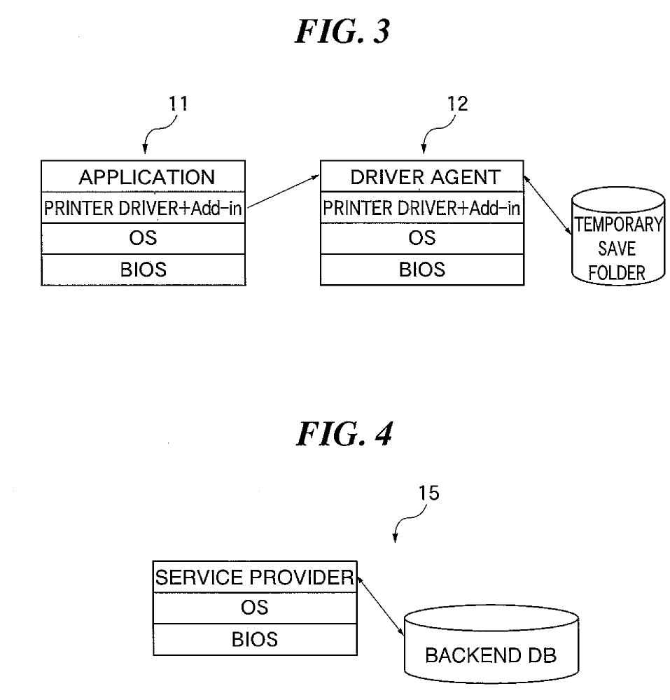

FIG. 3 shows a module configuration of software operating on the client PC 11 and the print server 12.

As shown in FIG. 3, in the print server 12, a printer driver for the printer 13, an Add-in module and a driver agent are operating on a platform such as the BIOS and the OS. Similarly, in the client PC 11, a printer driver for the printer 13 or the MFP 14, the Add-in module and the application are operating on the platform such as the BIOS and the OS. The Add-in module is a program module for adding a function of acquiring the job tracking information, to the printer driver. The function of acquiring the job tracking information can be added by applying the Add-in module to the printer driver without the function of acquiring the job tracking information. The driver agent saves the job tracking information passed by the Add-in module as the file in a temporary save folder. Also, the driver agent sends the job tracking information to the archive server 15.

FIG. 4 shows a module configuration of software operating on the archive server 15.

As shown in FIG. 4, in the archive server 15, a service provider is operating on the platform such as the BIOS and the OS. The service provider receives the job tracking information sent from the driver agent in the print server 12 or an MFP agent in the MFP 14, and accumulates the job tracking information in a backend database (hereinafter referred to as “the DB”) by a backend server. It should be noted that the backend server is assumed to be able to combine a document managing system or the database and the like depending on the size of the numbers of the printers and the MFPs or the number of the jobs to be handled.

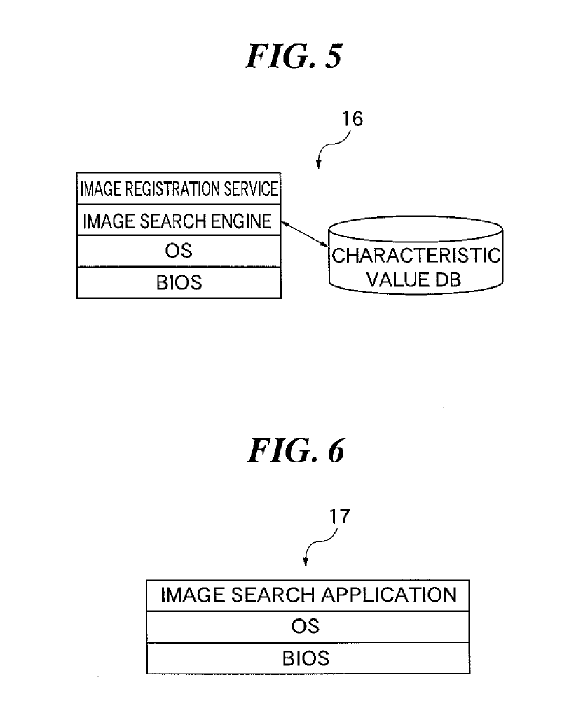

FIG. 5 shows a module configuration of software operating on the image search server 16.

As shown in FIG. 5, in the image search server 16, an image search engine is operating on the platform such as the BIOS and the OS, for registration as described below, based on the management by an image registration service. The registration refers to extracting the characteristic value of the image from the document images showing the output contents of the job accumulated in the archive server 15, and registering the characteristic value in a characteristic value DB. The image registration service and the image search engine are stored in the HDD 24, and when they are executed, they are loaded on the RAM 23 and executed under the control of the CPU 21.

FIG. 6 shows a module configuration of software operating on the image search client 17.

As shown in FIG. 6, in the image search client 17, an image search application is operating on the platform such as the BIOS and the OS. The image search application provides a function of displaying a collation image specification by the user and an image search result. It should be noted that the processes of extracting the characteristic value of the collation image, as well as comparing and collating the characteristic value of the collation image with the characteristic value of the search target image to calculate their similarity are performed by the image search engine in the image search server 16 under the management of the image search application.

As means for identifying a generation condition of the collation image, for example, it is conceivable to input whether the image is a scanned image or electronic data, as well as 24-bit color or 8-bit gray scale, by the user from a user interface of the image search application. The image search application is stored in the HDD 24, and when it is executed, it is loaded on the RAM 23 and executed under the control of the CPU 21.

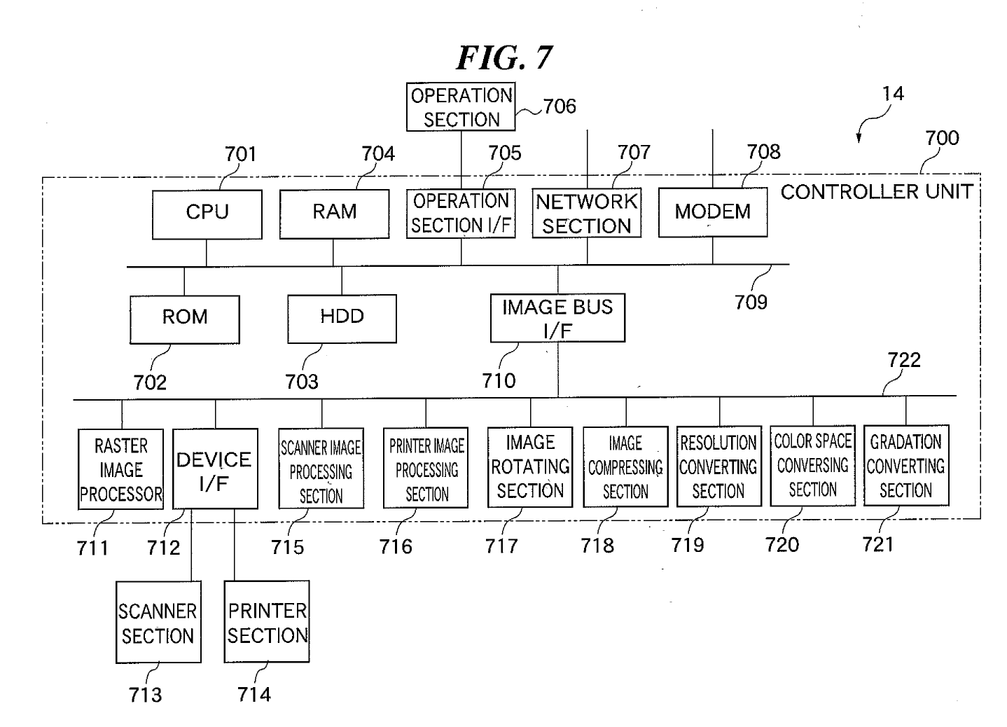

FIG. 7 is a block diagram showing a hardware configuration of the MFP 14 of FIG. 1.

As shown in FIG. 7, the MFP 14 includes a controller unit 700, an operation section 706, a scanner section 713, and a printer section 714. Furthermore, the controller unit 700 includes a CPU 701, a ROM 702, a HDD 703, a RAM 704, a network section 707, a modem 708, a scanner image processing section 715, a printer image processing section 716 and the like.

The controller unit 700 connects to the scanner section 713 (an image input device) and the printer section 714 (an image output device), thereby causing them to perform image reading of an original image (scan) and image forming (copy/print). On the other hand, the controller unit 700 connects to the network (LAN) 10 and a public circuit (WAN) to input and output various information including the image information between the MFP 14 and external devices.

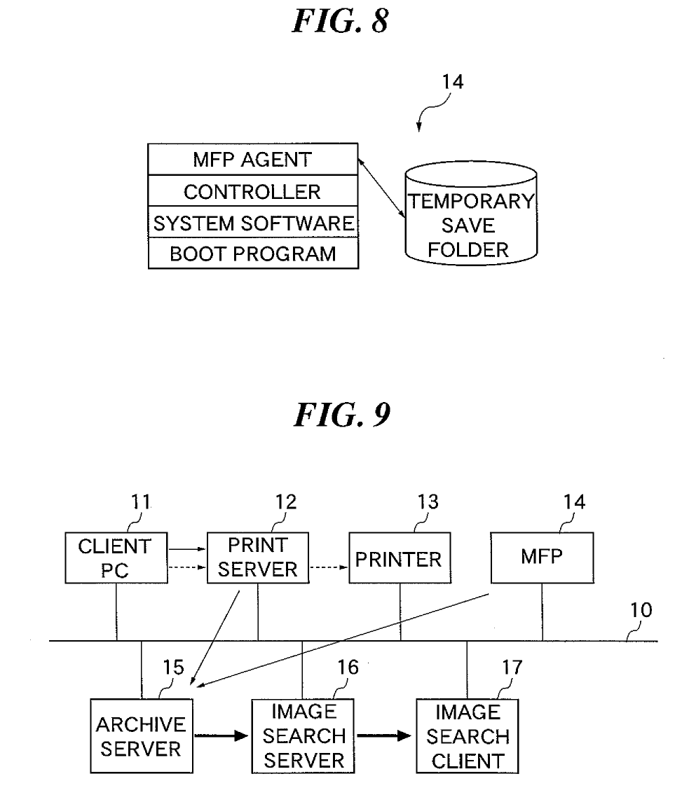

In the controller unit 700, the CPU 701 is a controller that controls the entire system. The RAM 704 is a system work memory for operation of the CPU 701, and is also an image memory (buffer memory) for temporarily storing the inputted image data. The ROM 702 is configured as a boot ROM, and stores a boot program of the system. The HDD 703 stores the system software and the image data. Also the job tracking information acquired by the MFP 14 (the job log information and the image information on the output contents on the job) is temporarily stored in the HDD 703, and transferred to the archive server 15 by the MFP agent of FIG. 8 as shown in FIG. 9.

An operation section I/F 705 takes charge of an interface with the operation section 706, and outputs the image data to be displayed with respect to the operation section 706. Also the operation section I/F 705 has a role of communicating information inputted by the user from the operation section 706 to the CPU 701. The network section 707 connects to the network (LAN) 10 to input and output the information. The modem (MODEM) 708 connects to the public circuit (WAN) to input and output the image information. An image bus (Image Bus) I/F 710 is a bus bridge for connecting a system bus 709 and an image bus 722 to convert data structures. The above described devices are arranged on the system bus 709.

The image bus 722 is a bus for transferring the image data at high speed, and is configured with a bus of the PCI (Peripheral Component Interconnect) standard or a bus of the IEEE (Institute of Electrical and Electronics Engineers) 1394 standard. The image bus 722 connects the following devices to one another on the image bus 722. A raster image processor (RIP) 711 expands the PDL (Page Description Language) code into a bitmap image. A device I/F 712 connects the scanner section 713, the printer section 714 and the controller 700 to convert synchronization scheme/asynchronization scheme of the image data.

The scanner image processing section 715 corrects, processes and edits the input image data read from the manuscript by the scanner section 713. Also the scanner image processing section 715 has a function of determining whether the input image data is color manuscript image data or monochrome manuscript image data, from a saturation signal of the image data, and retaining the result. The printer image processing section 716 corrects, processes and edits the output image data to be printed by the printer section 714.

An image rotation section 717, in cooperation with the scanner image processing section 715, rotates the image data and stores it in the memory, and also rotates the image data stored in the memory and stores it in the memory, simultaneously with reading the image at the scanner section 713. Alternatively, the image rotating section 717, in cooperation with the printer image processing section 716, can cause the printer section 714 to print and output the image data stored in the memory, while rotating the image data.

An image compressing section 718 performs a compression and expansion process in the JPEG (Joint Photographic Experts Group) method with respect to multivalued image data. The image compressing section 718 performs the compression and expansion process in the JBIG (Joint Bi-level Image Experts Group), the MMR (Modified Modified Read), the MR (Modified Read) and the MH (Modified Huffman) methods with respect to binary image data.

A resolution converting section 719 performs a resolution converting process with respect to the image data stored in the memory and stores the image data in the memory. A color space converting section 720 converts, for example, YUV image data stored in the memory into Lab image data with a matrix operation, and stores the Lab image data in the memory. A gradation converting section 721 converts, for example, 8-bit 256 gradation image data stored in the memory into 1-bit 2 gradation with a method such as an error diffusion process, and stores the image data in the memory.

The image rotating section 717, the image compressing section 718, the resolution converting section 719, the color space converting section 720 and the gradation converting section 721 as described above can operate in conjunction with one another. For example, if the image data stored in the memory is rotated and its resolution is converted, the image rotation process and the resolution conversion process can be performed without intervention of the memory.

FIG. 8 shows a module configuration of software operating on the MFP 14 of FIG. 7.

As shown in FIG. 8, in the MFP 14, the basic software, such as the boot program stored in the ROM 702 and the system software stored in the HDD 703, is executed by the CPU 701. On these basic programs, controller software (firmware) (simply shown as “controller” in FIG. 8) is executed by the CPU 701 by using the RAM 704. Furthermore, on the controller software, the MFP agent is executed by the CPU 701 by using the RAM 704. The MFP agent provides a function of transferring the job tracking information temporarily stored in the HDD 703 to the archive server 15.

FIG. 9 is a block diagram showing flows of the job tracking information and the printing data in the job history managing system.

As shown in FIG. 9, first, if the user has performed the printing instruction on the client PC 11, data itself of the Print job is sent via the print server 12 to the printer 13, and then printed and outputted by the printer 13. On the other hand, the job tracking information on the Print job is sent from the Add-in module on the client PC 11 to the driver agent on the print server 12, and temporarily stored in the temporary save folder on the print server 12 (FIG. 3).

Then, according to a predetermined schedule, the driver agent on the print server 12 sends the job tracking information to the archive server 15. In the archive server 15, the service provider (FIG. 4) receives the job tracking information, performs necessary image processing with respect to the job tracking information, and then stores the job tracking information in the backend DB.

Furthermore, the image registration service on the image search server 16 extracts the characteristic value of the search target image from the document images in the job tracking information stored in the backend DB, and registers the characteristic value in the characteristic value DB (FIG. 5). It should be noted that when the image is searched, the search result based on the comparison between the characteristic value of the search target image registered in the characteristic value DB and the characteristic value of the collation image is calculated.

If the user performs the operation of instructing to execute the job such as the Copy or the Send at the MFP 14, the instructed job is executed within the MFP 14. The job tracking information is extracted by the controller software (FIG. 8) on the MFP 14, once accumulated in the temporary save folder in the HDD 703, and then sent to the archive server 15 by the MFP agent. As to the subsequent flow, the same is true of the case of performing the printing operation by the client PC 11.

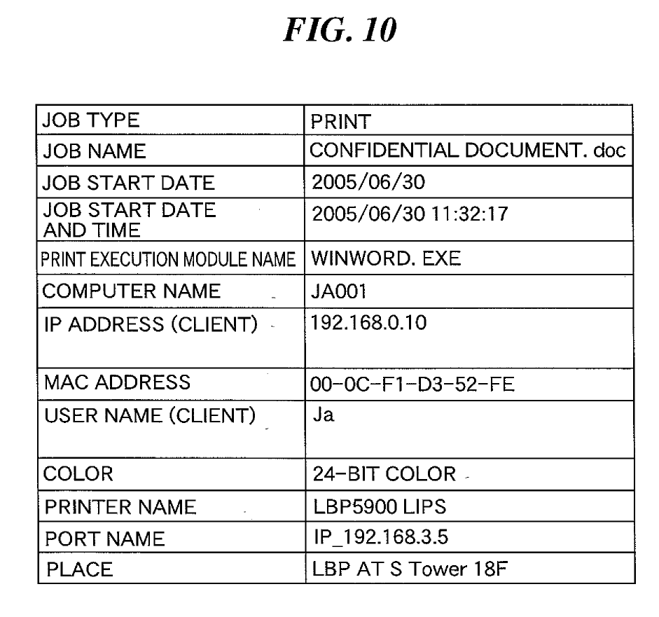

FIG. 10 shows an example of the job log information in the job tracking information of FIG. 9.

As shown in FIG. 10, an example of the job log information in the job tracking information is shown in a table format. The job log information includes job type for showing kinds of job (Copy, Print, Scan, Send and the like), job name, job start date, job start date and time, print execution module name, computer name, IP address, MAC address, user name, color, printer name, port name and place. In the flow of the job tracking information shown in FIG. 9, the job log information is sent to the archive server 15 in the table format of FIG. 10, and is accumulated in the backend DB, together with the image information or in association with the image information.

In this embodiment, a generation condition of the output contents of the job is identified from the job type and the color in the job log information, and the process of extracting the characteristic values of the search target image and the collation image, and the process of comparing and collating the search target image with the collation image when the search is performed are modified. For example, if the job type is Print, the document image to be stored in the backend DB has relatively high image quality, and the comparison and collation process is expected to be accurately performed. However, if the job type is Copy or Send, since the image is degraded due to scanning the manuscript by the scanner section 713 of the MFP 14, a correction process is required to be performed with respect to the scanned image data, in order to perform the comparison and collation process more accurately.

Moreover, if the color of the image is 8-bit gray scale, the characteristic value of gray scale may be directly extracted. If the color of the image is 24-bit color, it is necessary to previously extract both of the characteristic value of 24-bit color and the characteristic value of gray scale and prepare them so that both of them can be used when the search is performed. In this embodiment, the search target image and the collation image are assumed to be either 24-bit color or 8-bit gray scale.

Typically, if the image search is performed, the characteristic value of the search target image is extracted, and how much the characteristic value of the search target image is similar to the characteristic value of the collation image used for comparing and collating with the search target image is calculated as the similarity. In this embodiment, due to a property of the job history managing system, a large amount of information on the search target image included in the job tracking information is generated, and therefore daily job tracking information is accumulated in the backend DB in the archive server 15. Simultaneously with this, it is also necessary to perform the extraction of the characteristic values of the image information in the image search server 16 and the registration of the characteristic values in the characteristic value DB.

Therefore, in this embodiment, the following two controls are taken into consideration. The first control is to switch the process of extracting the characteristic value of the image information, depending on the difference in the generation condition of the image information on the output contents of the job. The second control is to switch the process of comparing and collating the search target image with the collation image, depending on the difference in the generation condition of the collation image when the search is performed.

It should be noted that, in this embodiment, the process of extracting and registering the characteristic value of the image information, when the image information is accumulated in the backend DB in the archive server 15, is performed at the following timing. In other words, for example, after the image information in one day has been accumulated, their characteristic values are extracted and registered together.

Here, the calculation of the characteristic value of the image information will be described below.

As a method of calculating the characteristic value, there is a known calculation method. In this embodiment, a numeric value converted from any one of color information, luminance, and form in the image information is extracted with respect to each image included in the image data accumulated in the backend DB in the archive server 15, and the collation image information, respectively. These numeric values are set to the characteristic values.

An example of the calculation of the characteristic value in this embodiment will be described below. First, the characteristic value of the color information will be described. First, the image information on a target of extracting the characteristic value is divided into four vertically and horizontally, respectively. In other words, the image information is divided into 4×4 blocks. The characteristic value of the color information on each block is set to an average value within the block when the image information is represented in each 8-bit RGB.

In the collation process described below, addition of differences among the average values of corresponding blocks for all the blocks is calculated as “distance” of the characteristic value of the color information. It is assumed that the less the “distance” is, the higher the similarity is.

Next, the characteristic value of the luminance will be described. The image information on the target of extracting the characteristic value is divided into 4×4 blocks. The characteristic value is set to the average value within the block when luminance information in the image information is represented in 8-bit.

In the comparison process described below, addition of differences among the average values of the corresponding blocks for all the blocks is calculated as the “distance” of the characteristic value of the luminance. It is assumed that the less the “distance” is, the higher the similarity is.

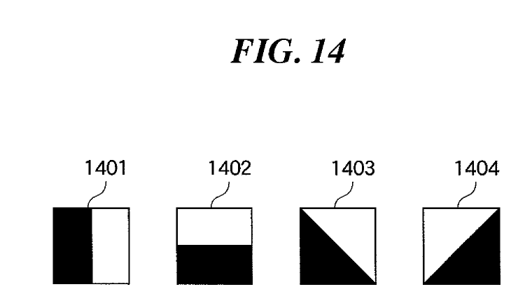

Finally, the characteristic value of the form will be described. The image information on the target of extracting the characteristic value is divided into 4×4 blocks. Then, it is determined how much four patterns defined in FIG. 14 (1401 to 1404) are included in the block. The determination is converted into the numeric value as a histogram, which is set to the characteristic value. FIG. 14 shows the characteristic value of the form.

In this embodiment, although the characteristic value is calculated by the above described method, the characteristic value may be calculated by the other calculation method if the characteristic value can be used for determination of the similarity of the image information.

In the comparison and collation process, addition of absolute values of the differences among the histograms of the corresponding blocks for all the blocks is calculated as the “distance” of the characteristic value of the form. It is assumed that the less the “distance” is, the higher the similarity is.

Next, the extraction and registration process of the characteristic value of the image information will be described. The image registration service (FIG. 5) on the image search server 16 sequentially processes the image information on the output contents of the job included in the job tracking information in one day accumulated in the backend DB (FIG. 4) of the archive server 15. On this occasion, the registration process shown in FIG. 11 is started.

FIG. 11 is a flowchart showing a procedure of the registration process executed by the image search server 16.

As shown in FIG. 11, in step S101, the image search server 16 determines whether or not the first image information is a scanned image, with reference to an item of “job type” in the job log information table (FIG. 10). If it is determined that the first image information is the scanned image in step S101, the image search server 16 performs a process of removing black floating/white jumping for correcting the scanned image in step S102, followed by proceeding to step S103. If it is determined that the first image information is not the scanned image in step S101, that is, if the job type is Print and the like, the procedure proceeds directly to step S103. It should be noted that the process of removing black floating/white jumping is to sharpen edges of the image or correcting pale portions of the image.

In step S103, the image search server 16 determines whether the first image information is a color (24-bit color) image or a gray (8-bit gray scale) image, with reference to an item of “color” in the job log information table (FIG. 10). If it is determined that the first image information is the color image, the image search server 16 extracts the characteristic value of color with the image search engine based on the instruction from the image registration service (FIG. 5), and registers the characteristic value in the characteristic value DB, in step S104. Next in step S105, the image search server 16 converts the color image into the gray scale image, followed by proceeding to step S106.

If it is determined that the first image information is not the color image in step S103, the procedure proceeds directly to step S106 where the image search server 16 extracts the characteristic value of gray scale and registers it in the characteristic value DB, followed by terminating the registration process to be completed. In addition, for example, it is assumed that the characteristic value of color consists of the luminance, the color information and the form, and the characteristic value of gray scale consists of the luminance and the form. As the characteristic value, in addition to the above, the characteristic value may be obtained from other parameters representing the characteristics of the respective images of color and gray scale.

The characteristic values of the image information with respect to the job tracking information in one day are registered in the characteristic value DB, by performing the above described process in steps S101 to S106 with respect to the image information in one day accumulated in the backend DB, until the last image information thereof. This registration process is performed within the schedule set by an administrator of the job history managing system, which enables the characteristic values of the image information with respect to daily job tracking information to be continuously registered, and used for the image search when a leakage of information has occurred.

Next, the search process will be described below.

For example, the case is considered where the image which has been outputted by executing the job by the MFP 14 or the printer 13 (the printed and outputted image or the image sent as the image data to outside) is a confidential image and it has been discovered that this confidential image has been leaked to outside of a company. If the same image data as the leaked image has been accumulated in the archive server 15, referring to the job log information on the image data provides a key to know the cause of the leakage of the image. In this way, the search process is performed for identifying the same image data as one image (the printed and outputted image or the image data) or the image data having the high similarity to the one image, from a great volume of image data stored in the archive server 15.

Hereinafter, the image stored in the archive server 15 is referred to as “the search target image”, and the leaked image in the above described case is referred to as “the collation image”.

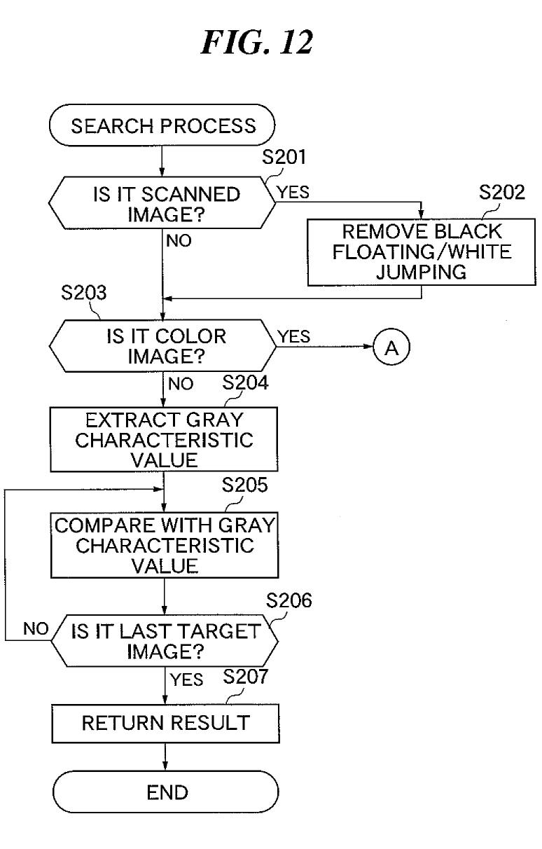

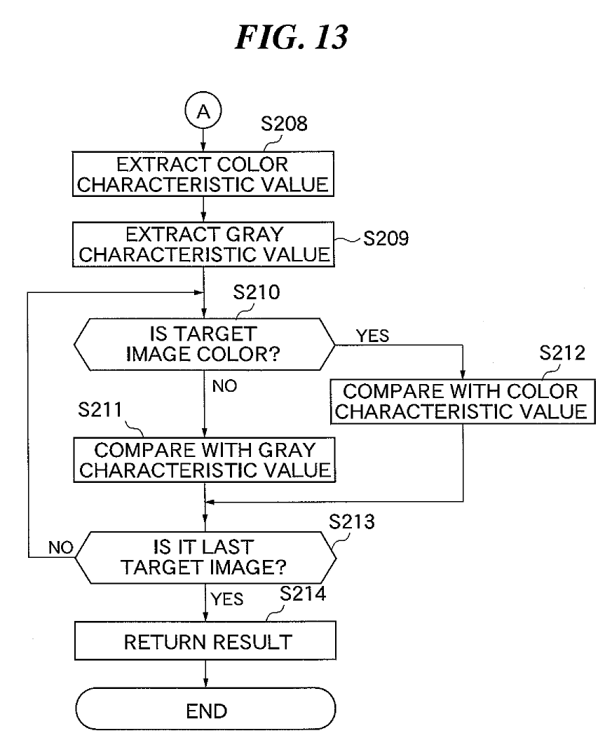

The collation image used for comparing and collating with the search target image is specified by the user from the user interface of the image search application (FIG. 6) on the image search client 17. In this case, the generation condition of the collation image, and whether the collation image is the scanned image, the color image or the gray scale image are assumed to be simultaneously specified. On this occasion, the search process shown in FIGS. 12 and 13 is started.

FIGS. 12 and 13 are flowcharts showing a procedure of the search process executed by the image search server 16.

As shown in FIGS. 12 and 13, in step S201, the image search server 16 determines whether or not the specified collation image is the scanned image. Whether or not the specified collation image is the scanned image may be determined based on the specification by the user from the user interface of the image search application. Alternatively, if the collation image is set to be inputted by using the scanner (not shown), it may be determined as the scanned image with the setting.

If it is determined that the collation image is the scanned image in step S201, the image search server 16 performs the process of removing black floating/white jumping for correcting the scanned image in step S202, and the procedure proceeds to step S203. If it is determined that the collation image is not the scanned image in step S201, that is, if it is original electronic data, the procedure proceeds directly to step S203.

In step S203, the image search server 16 determines whether or not the collation image is the color image. The determination of whether or not the collation image is the color image may be carried out based on the specification by the user from the user interface of the image search application. Alternatively, a heretofore known chromatic color/achromatic color determination technology may be applied with respect to the specified collation image to determine the collation image based on the result of the above described determination. If it is determined that the collation image is not the color image in step S203, the image search server 16 extracts the characteristic value of the gray scale image with the image search engine based on the instruction from the image search application in step S204.

Next in step S205, the image search server 16 performs the following process. The image search server 16 compares the characteristic value of gray scale of the search target image with the characteristic value of gray scale of the collation image, among the characteristic values registered in the characteristic value DB corresponding to the image information on the search target (the image of the target of calculating the similarity with the collation image) on the backend DB, and calculates their similarity. Next in step S206, the image search server 16 checks whether or not it is the last image information among the image information on the search target. If it is determined that it is not the last image information on the search target in step S206, the procedure returns to step S205. The processes in these steps S205 and S206 are repeated until the last image information on the search target.

If it is determined that it is the last image information on the search target in step S206, the image search server 16 returns the similarities calculated with respect to the image information on all search targets for the image search engine, to the image search application as the search result. The image search application displays the search result on the user interface, followed by terminating the search process. In addition, it is assumed that the specification of the search target image is performed by the user with a time period in which the job has been executed/the job type and the like, on the user interface of the image search application in the image search server 16.

If it is determined that the collation image is the color image in step S203, the image search server 16 extracts the characteristic value of color in step S208. Next in step S209, the image search server 16 converts the color collation image into gray scale, and extracts the characteristic value of gray scale. Then in step S210, the image search server 16 examines whether the image information on the search target is color or gray scale. This examination can be carried out by referring to the item of “color” in the job log information table (FIG. 10) related to the search target image.

If it is determined that the image information on the search target is gray scale in step S210, the image search server 16 performs the following process in step S211. The image search server 16 compares the characteristic value of gray scale of the search target image, for example, the luminance and the form, with the characteristic value of gray scale of the collation image, and calculates the similarity between the search target image and the collation image.

If it is determined that the image information on the search target is color in step S210, the image search server 16 performs the following process in step S212. The image search server 16 compares the characteristic value of color of the search target image, for example, the luminance, the color information and the form, with the characteristic value of color of the collation image, and calculates the similarity between the search target image and the collation image. It should be noted that if the search target image is color, both of the collation image and the search target image have both of the color characteristic value and the gray scale characteristic value; therefore, both characteristic values may be compared.

Next in step S213, the image search server 16 checks whether or not it is the last image information among the image information on the search target. If it is determined that it is not the last image information on the search target in step S213, the procedure returns to step S210. The processes in these steps S210 to S213 are repeated until the last image information on the search target.

If it is determined that it is the last image information on the search target in step S213, the image search server 16 performs the following process in step S214. The image search server 16 returns the similarities calculated with respect to the image information on all search targets for the image search engine, to the image search application as the search result. The image search application displays the search result on the user interface, followed by terminating the search process.

Next, as a second embodiment of the present invention, examples of other search processes performed by the image search server 16 will be described.

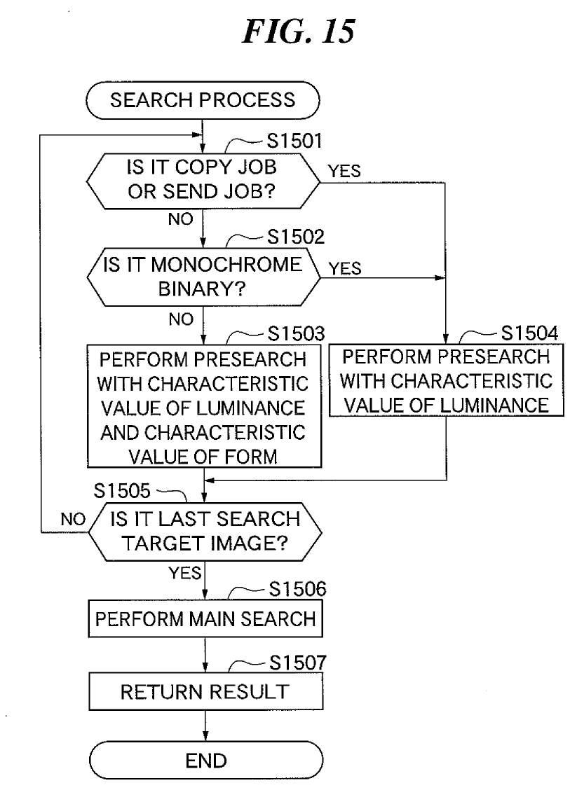

A configuration of a system job history managing system including the image search server 16 in the second embodiment, configurations of respective hardware, a configuration of software, the flow of the job tracking information, and the contents of the job tracking information are assumed to be the same as those shown in FIGS. 1 to 10. Also, the image search server may be able to execute both of the search processes shown in flowcharts of FIGS. 12 and 13 the search process shown in FIG. 15.

The search process in the second embodiment intends to reduce a processing time by dividing the comparison and collation process with respect to the collation image and the search target image into two stages of presearch and main search. The main search uses the characteristic value obtained by dividing the image information into 4×4 blocks as described above.

On the other hand, the presearch uses the characteristic value obtained by dividing the image in the document image into two vertically and horizontally, respectively (dividing into 2×2 blocks) and extracting the characteristic value from each block. The presearch has a property of having a coarser collation accuracy and less processing time than the main search. The presearch narrows down the search target image and then the main search is performed, which can reduce the time of the entire collation process.

Furthermore, in this embodiment, the comparison and collation process in the presearch is switched depending on what kind of job has generated the search target image accumulated in the archive server 15 (referred to as “the job generation condition”), which prevents a search leakage in the presearch.

Moreover, in this embodiment, it is assumed that the MFP 14 in FIG. 1 is configured with a monochrome MFP and the printer 13 is configured with a color printer. The MFP 14 includes multiple functions for copying, sending and printing. The printer 13 includes the printing function.

In addition, if the MFP 14 of this embodiment executes the Copy job and the Send job, the image information used in the execution of the job is assumed to be the binary image data. On the other hand, the MFP 14 is assumed to use the multivalued image data for the Print job. If the printer 13 executes the Print job, the printer 13 is assumed to use the multivalued image data.

FIG. 15 is a flowchart showing another example of the search process executed by the image search server, and is the flowchart showing a procedure of switching the comparison and collation process based on the job generation condition of the search target image. The CPU in the image search server 16 executes the flowchart of FIG. 15.

In FIG. 15, when the search instruction is accepted with the collation image from the image search client 17, the execution of this flowchart is started. First in step S1501, with reference to the job tracking information (FIG. 10) associated with the characteristic value for the presearch accumulated in the image search server 16 of FIG. 1, the job type of the search target image is identified. The identification of the job type enables to identify what kind of job has used the image data in the MFP 14 or the printer 13, with respect to the search target image.

If the job type is “Copy” or “Send”, the procedure proceeds to step S1504. If the job type is neither “Copy” nor “Send” (for example, if the job type is “Print”), the procedure proceeds to step S1502 where the color of the image data from which the characteristic value for the presearch has been extracted is examined. As a result of examining the color of the image data, if the color is monochrome binary, the procedure proceeds to step S1504, otherwise the procedure proceeds to step S1503. In step S1503, both of the luminance and the form in the characteristic value for the presearch are used to calculate the similarity between the search target image and the collation image, and the procedure proceeds to step S1505. On the other hand, in step S1504, the luminance in the characteristic value for the presearch is used to calculate the similarity between the search target image and the collation image, and then the procedure proceeds to step S1505.

In step S1505, it is determined whether or not characteristic value data on which the presearch is performed is the characteristic value data of the last search target image stored in the characteristic value DB. If the characteristic value data on which the presearch is performed is the characteristic value data of the last search target image stored in the characteristic value DB, the procedure proceeds to step S1506, otherwise the procedure returns to step S1501.

Then in step S1506, as a result of the presearch executed in steps S1503 and S1504, the main search is performed with respect to the search target image data having the characteristic value from which the similarity equal to or more than a certain threshold has been calculated. In the main search, the collation with the accuracy higher than the presearch is performed in which, for example, the target image is divided into 4×4 or 8×8 blocks and the data is used in which the luminance, the form and the color information of each block have been extracted as the characteristic value. Then in step S1507, the similarities of the respective target images obtained as a result of the main search are returned to the image search client 17 as the result of the collation process, followed by terminating the search process.

In the case of performing the presearch with respect to the search target image stored in the archive server 15, if the presearch using the characteristic value of the form is performed with respect to a monochrome image, particularly the binary image, the search leakage has been likely to occur. This is because, in the monochrome image, particularly the binary image, the image data significantly changes in its characteristic value of the form even if the image data has very slightly changed (degradation in the image data, or blots or changes in color of the printed output). Hence, if the similarity is determined with the characteristic value of the form with respect to the monochrome image or the binary image, the similarity is highly likely to be determined to be a low similarity even with respect to the image originally having a high similarity, due to erroneous determination.

In this embodiment, if the job is the kind in which the search target image handles the monochrome binary image, the presearch is performed without using the characteristic value of the form, which prevents the search leakage.

It should be noted that, as a method of specifying the job generation condition of the search target image according to this embodiment, the user may specify the job generation condition when the search is performed. For example, when the search is performed, the user can specify the image as the 24-bit color image or the other image in the setting of the search target image when it is generated. There is also a method of switching the collation process in which the presearch is performed with both of the form and the luminance in the case of the 24-bit color image, and the presearch is performed only with the luminance in the case of the image other than 24-bit color. Similarly this method also can significantly improve the search leakage in the presearch.

As described above, according to this embodiment, the process of extracting the characteristic value of the image information is switched depending on the difference in the generation condition of the image information on the output contents of the job. Also, the comparison and collation process with respect to the search target image and the collation image is switched depending on the difference in the generation condition of the collation image when the search is performed. This provides an effect of efficiently narrowing down, for example, even if the image information has been leaked, the job corresponding to the leaked image information, and furthermore provides another effect of eliminating variation in the search results due to the difference in the generation condition of the image information on the output contents of the job (Print, Copy, Send, color, gray scale and the like), and realizing the search result with the high accuracy.

Although in the above described embodiment, the example in the case of the job history managing system having the configuration shown in FIG. 1 has been described, the job history managing system of the present invention is not limited to a specific configuration. The numbers, the kinds, combination and the like of the components of the job history managing system can be arbitrarily set in a range not deviating from the gist of the present invention. For example, various other variations are conceivable in which the image search server 16 also uses the function of the archive server 15, and the like.

Moreover, the object of the present invention is accomplished by executing the following process. In other words, this process is a process in which a storage medium having recorded thereon a program code of software for realizing the functions of the above described embodiments is supplied to a system or an apparatus, and a computer (or a CPU, an MPU or the like) of the system or the apparatus reads the program code stored in the storage medium.

In this case, the program code itself read from the storage medium realizes the functions of the above described embodiments, and hence the program code and the storage medium in which the above described program code is stored constitute the present invention.

Moreover, as the storage medium for supplying the program code, the following media can be used, including, for example, a floppy (registered trademark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, a ROM and the like. Alternatively, the program code may be downloaded via a network.

Also, the present invention includes the case where the functions of the above described embodiments are realized by executing the program code read out by the computer. In addition, the present invention also includes the case where an OS (operating system) or the like operating on the computer performs a part or all of actual processes based on instructions from the program code, and the process realizes the functions of the above described embodiments.

Furthermore, the present invention also includes the case where the functions of the above described embodiments are realized by the following process. In other words, the program code read out from the storage medium is written into a memory provided on a function expansion board inserted into the computer or in a function expansion unit connected to the computer. Then a CPU or the like provided in the function expansion board or the function expansion unit performs a part or all of the actual processes based on the instructions from the program code.

### INDUSTRIAL APPLICABILITY

The present invention provides an effect of efficiently narrowing down, for example, even if image information has been leaked, a job corresponding to the leaked image information, and furthermore provides another effect of eliminating variation in search results due to the difference in a generation condition of the image information on output contents of the job, and realizing the search result with a high accuracy can be obtained.

1. A job history managing system comprising:
a collecting unit adapted to collect job tracking information including a search target image which is image information related to output contents of a job outputted from a job outputting apparatus;
a managing unit adapted to accumulate said job tracking information collected by said collecting unit;
a registering unit adapted to extract and register a characteristic value of the image information on said search target image in said job tracking information accumulated by said managing unit; and
a switching unit adapted to switch a process of extracting the characteristic value of the image information on said search target image, depending on a generation condition of said job.

2. A job history managing system according to claim 1, wherein said job tracking information includes job log information, and said job log information includes a kind of the job.

3. A job history managing system according to claim 1, wherein said job outputting apparatus includes a printer and a multi function peripheral, and kinds of the job outputted from said job outputting apparatus include Print, Copy and Send.

4. A job history managing system according to claim 3, wherein said registering unit is adapted to switch the process of extracting the characteristic value of the image information on the output contents of said job, depending on the kind of said job and/or whether the image information on the output contents of said job is color or gray scale.

5. A job history managing system according to claim 1, further comprising a comparing unit adapted to compare said search target image with a collation image based on the characteristic value of the image information on said search target image registered by said registering unit, wherein a comparison process with respect to said search target image and said collation image performed by said comparing unit is switched depending on a generation condition of said search target image.

6. A job history managing system according to claim 5, wherein said comparing unit is adapted to switch the comparison process with respect to said search target image and said collation image, depending on a generation condition of said collation image.

7. A job history managing system according to claim 1, wherein said registering unit is adapted to extract the characteristic value based on any one of luminance, color information and form in the image information.

8. A job history managing system comprising:
an accumulating unit adapted to accumulate job tracking information including search target image which is image information related to output contents of a job outputted from a job outputting apparatus;
a registering unit adapted to extract and register a characteristic value of said search target image in said job tracking information accumulated by said accumulating unit;
a comparing unit adapted to compare said search target image with a collation image based on the characteristic value of the image information on said search target image registered by said registering unit; and
a switching unit adapted to switch a comparison process in said comparing unit based on a generation condition of said job.

9. A job history managing system according to claim 8, wherein said comparing unit is adapted to perform a presearch having a low comparison accuracy and a main search having a high comparison accuracy in the comparison process with respect to said search target and said collation image.

10. A job history managing system according to claim 9, wherein said switching unit is adapted to switch a process of the presearch performed by said comparing unit, based on the generation condition of said job.

11. A job history managing system according to claim 10, wherein the registering unit is adapted to extract multiple kinds of characteristic values from the image information on said search target image and said switching unit is adapted to switch the kind of the characteristic value to be used in the presearch performed by said comparing unit, based on the generation condition of said job.

12. A job history managing system according to claim 11, wherein the multiple kinds of characteristic values extracted by said registering unit are any one of the characteristic value based on color information, the characteristic value based on luminance, and the characteristic value based on form, in the image information on said search target image.

13. A job history managing system according to claim 8, wherein said job tracking information includes job log information, said job log information includes a kind of the job, and said switching unit switches the comparison process in said comparing unit, based on the kind of the job included in said job log information.

14. A method of controlling a job history managing system, comprising:
a collecting step of collecting job tracking information including search target image which is image information related to output contents of a job outputted from a job outputting apparatus;
a managing step of accumulating said job tracking information collected by said collecting step;
a registering step of extracting and registering a characteristic value of the image information on said search target image in said job tracking information accumulated by said managing step; and
a switching step of switching a process of extracting the characteristic value of the image information on said search target image, depending on a generation condition of said job.

15. A method of controlling a job history managing system, comprising:
an accumulating step of accumulating job tracking information including search target image which is image information related to output contents of a job outputted from a job outputting apparatus, in an accumulating unit;
a registering step of extracting a characteristic value of said search target image in said job tracking information accumulated by said accumulating step, and registering the characteristic value in an registering unit;
a comparing step of comparing said search target image with a collation image based on the characteristic value of the image information on said search target image registered by said registering step; and
a switching step of switching a comparison process in said comparing step, based on a generation condition of said job.

16. A computer-readable storage medium storing a program for causing a computer to execute a method of controlling a job history managing system according to claim 14.

17. A computer-readable storage medium storing a program for causing a computer to execute a method of controlling a job history managing system according to claim 15.
